(19) United States
(12) Patent Application Publication
(10) Pub. No.: US 2026/0299536 A1
(43) Pub. Date: Oct. 1, 2026

(54) WORK MACHINE WITH A USER INTERFACE FOR RECEIVING USER INPUT INSTRUCTIONS IN RELATION TO WORK MACHINE FUNCTIONALITY

(71) Applicant: Caterpillar Inc., Peoria, IL (US)

(72) Inventors: Samuel Alec ROBERTS, Stamford (GB); Amy Caitlin MITCHELL, Spalding (GB)

(21) Appl. No.: 19/477,666

(22) PCT Filed: Mar. 13, 2024
(86) PCT No.: PCT/US2024/019633

§ 371 Date: Oct. 22, 2025

(30) Foreign Application Priority Data
Apr. 26, 2023 (GB) 2306135.1

(51) Int. Cl. G05B 15/02; G06F 3/0484

(52) U.S. Cl. CPC G05B 15/02; G06F 3/0484

(57) ABSTRACT

A work machine comprises one or more functionality controllers configured to control one or more areas of work machine functionality. The work machine also comprises a user interface configured to: (a) receive user input instructions in relation to the one or more areas of work machine functionality; (b) send the user input instructions to the one or more functionality controllers; and (c) output a plurality of operation status indicators in accordance with a timetable. The work machine further comprises a monitoring system configured to receive the plurality of operation status indicators and to determine whether the plurality of operation status indicators is received in accordance with a rule. The monitoring system is configured such that, in an event that the plurality of operation status indicators is determined not to be received in accordance with the rule, the monitoring system provides an instruction to the one or more functionality controllers to return each of the one or more areas of work machine functionality to a default state.

### TECHNICAL FIELD

The disclosure relates to work machines with a user interface, such as a touch screen device, configured to enable user input across one or more areas of work machine functionality on the user interface.

### BACKGROUND

It is increasingly common to provide a user interface, such as a single touch screen device, to enable user input across one or more areas of work machine functionality. Such functionality might include headlights, work lights, heating, ventilation, air-conditioning, entertainment, satellite navigation and many other aspects of machine functionality.

This gives rise to the possibility that in the event of a fault with the user interface, it may not be possible for the user to provide an input to control work machine functionalities.

### SUMMARY OF THE DISCLOSURE

Against this background, there is provided a work machine comprising:
one or more functionality controllers configured to control one or more areas of work machine functionality;
a user interface configured to:
(a) receive user input instructions in relation to the one or more areas of work machine functionality;
(b) send the user input instructions to the one or more functionality controllers; and
(c) output a plurality of operation status indicators in accordance with a timetable; and
a monitoring system configured to receive the plurality of operation status indicators and to determine whether the plurality of operation status indicators is received in accordance with a rule;
wherein the monitoring system is configured such that, in an event that the plurality of operation status indicators is determined not to be received in accordance with the rule, the monitoring system provides an instruction to the one or more functionality controllers to return each of the one or more areas of work machine functionality to a default state.

In this way, if a user interface such as a touch screen display ceases to operate per its specification, action is taken to return the machine functionality that is normally controllable by the user interface to a default state.

This may, for example, include one or more of returning heating, ventilation and/or air conditioning to default conditions, switching a cab radio to be off, returning headlights to standard settings, return work lights to standard settings, etc.

### BRIEF DESCRIPTION OF THE DRAWINGS

FIG. 1 is a highly schematic representation of a work machine in accordance with the present disclosure;

FIG. 2 is a flow chart illustrating high level functionality of the work machine of the present disclosure in accordance with a first embodiment of the disclosure; and

FIG. 3 is a flow chart illustrating high level functionality of the work machine of the present disclosure in accordance with a second embodiment of the disclosure.

### DETAILED DESCRIPTION

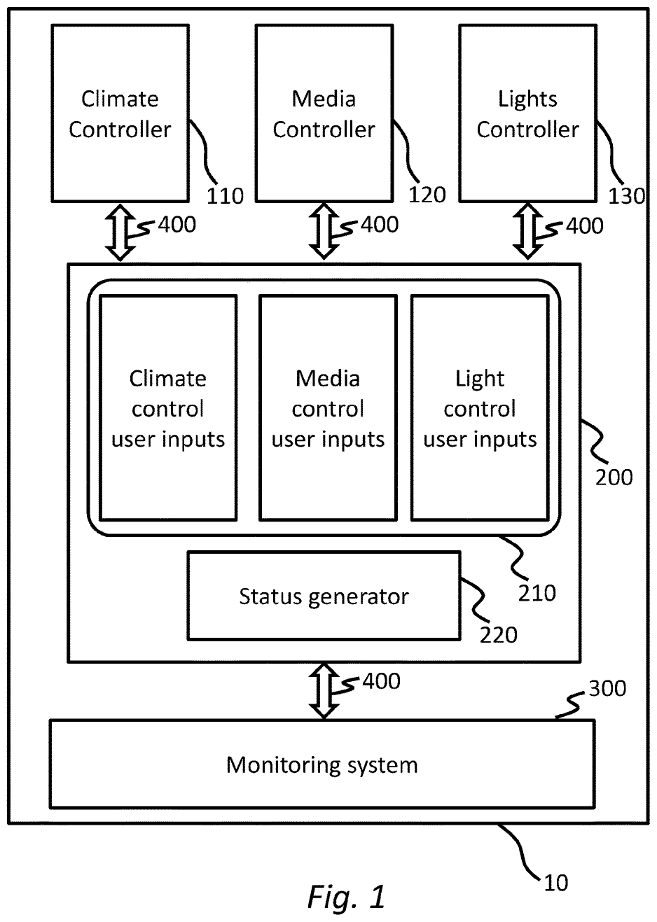

FIG. 1 shows a work machine 10 in accordance with the present disclosure. The work machine 10 comprises one or more functionality controllers which may include a climate controller 110, a media controller 120 and a lights controller 130. The work machine 10 further comprises a user interface 200 and a monitoring system 300.

Where present, the climate controller 110 may control one or more of heating, ventilation and cooling of a cab of the work machine. Where present, the media controller 120 may control a radio or other entertainment provision inside the cab of the work machine. Where present, the light controller 130 may control one or more of headlights of the work machine and/or work lights of the work machine and/or interior lights of the work machine.

The user interface 200 is configured to receive user input instructions in relation to the one or more areas of work machine functionality. The user interface 200 may comprise a touch screen display 210. Alternatively, or in addition, the user interface 200 may comprise a voice activated controller. Alternatively, or in addition, the user interface 200 may comprise physical controls, such as buttons and/or dials. The user interface 200 is configured to receive user instructions in relation to the one or more areas of work machine functionality and transmit the user input instructions to the one or more functionality controllers 110, 120, 130. If a touch screen display 210 is used, the touch screen display 210 may comprise a plurality of menus for controlling the one or more areas of work machine functionality. Alternatively, all controls may be available simultaneously on the touch screen without being divided between different menus.

The user interface 200 also comprises a status generator 220. The status generator 220 is configured to output a plurality of operation status indicators in accordance with a timetable. The operation status indicators may be dedicated status indicator messages or may be embedded within other data, such as within the transmission of the user input instructions to one of the one or more functionality controllers. In one embodiment, the plurality of operation status indicators output in accordance with the timetable may comprise a status ping output at a fixed frequency. The status generator 220 is configured to output the plurality of operation status indicators in accordance with a timetable only when the user interface is capable of receiving the user input instructions. Thus, if the user interface has crashed such that the user interface is not capable of receiving user input instructions, it also does not output the plurality of operation status indicators in accordance with the timetable.

The user interface 200 is further configured to send the user input instructions to the one or more functionality controllers 110, 120, 130 and to send the operation status indicators in accordance with the timetable to the monitoring system 300. The monitoring system 300 may comprise one of the one or more functionality controllers 110, 120, 130 and, in such an arrangement, the operation status indicators may be sent to one or the one or more functionality controllers 110, 120, 130.

The user input instructions and/or the operation status indicators may be sent via a communications network 400. The communications network may be a wired communications network. For example, the communications network may comprise an ethernet network. The communications network may comprise a CAN network. The communications network may comprise a wireless network.

The monitoring system 300 is configured to determine whether the plurality of operation status indicators is received by the monitoring system 300 in accordance with a rule. For example, where the plurality of status indicators in accordance with the timetable comprises a status ping output at a fixed frequency, the rule may be to determine that a maximum period between receipt of pings is not exceeded. For example, the rule may be considered to have been broken if a period equivalent to the expected transmission period of, say, 1, or 2, or 5 or 10 status pings passes without any status pings being received.

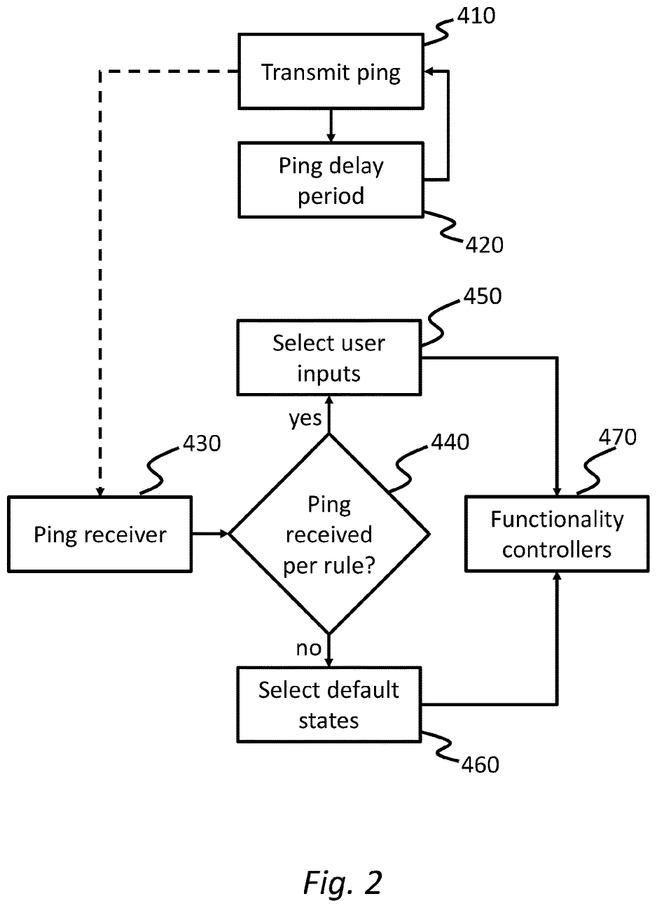

FIG. 2 shows a highly schematic process flow for the work machine in accordance with the present disclosure. A ping is transmitted at step 410 and a delay is implemented at step 420 prior to transmission of a subsequent ping at step 410. Steps 410 and 420 may be arranged in a continuous loop. A ping receiving step is provided at step 430. At step 440 a determination is made as to whether the ping is received in accordance with a rule based on a ping timetable. For example, the rule may be that a ping is received at least once in a period equivalent to the transmission of a set number of pings, for example 1 ping, or 2 pings, or 5 pings, or 10 pings.

Thus, it may be that if the period passes without a ping being received at step 430, the rule is considered to have been breached. On the other hand, if a ping is received at step 430 within the period then the rule is considered to have been met.

In an event that the rule is met, the user inputs are used as inputs to the one or more functionality controllers 110, 120, 130. In an event that the rule is breached, default states may be used as inputs to the one or more functionality controllers 110, 120, 130. In this way, defaults may be applied such as default climate control, radio off and default lighting.

In one implementation, it may not be that there is an active check for the ping prior to using the user inputs to the one or more functionality controllers. Rather, it may be that in the event that the ping is not received in accordance with the rule, this interrupts logic in order to override use of user inputs and replace them with default state inputs to the one or more functionality controllers.

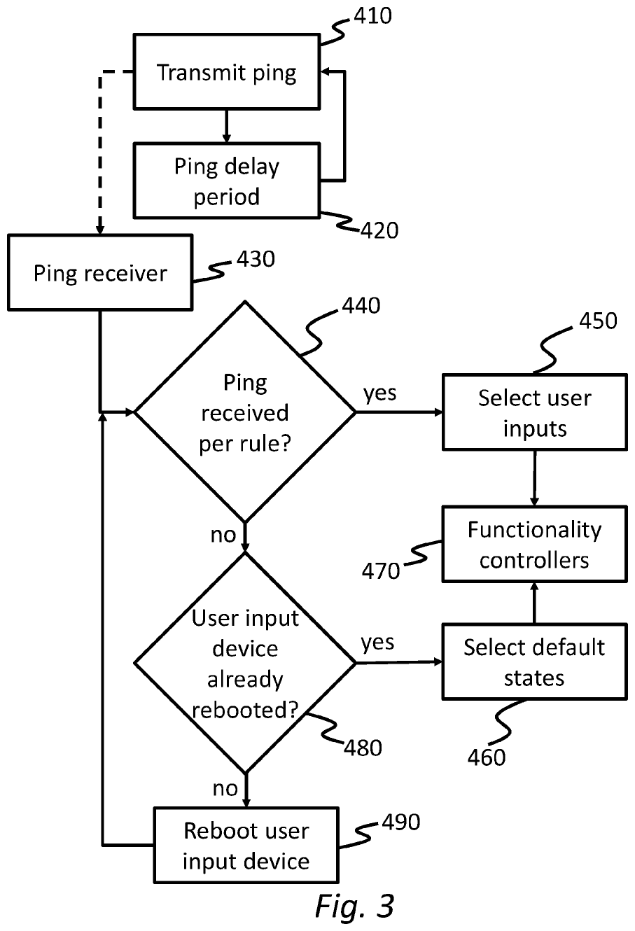

A variation on the FIG. 2 arrangement is shown in FIG. 3. In the FIG. 3 arrangement, if the rule is breached, an attempt is made to reinitiate/reset/reboot the user interface device before actioning the step of returning each of the one or more areas of work machine functionality to the default state. This is shown as steps 480 and 490 in FIG. 3.

If the user input device is reset, the reset may be a soft reset or a hard reset.

Optionally, the step of reinitiating the user interface comprises first saving user input instructions to memory prior to providing the command to the user interface to reinitiate the user interface. Then, once the user interface is reinitiated, the user input instructions may be retrieved from memory and sent to the one or more functionality controllers.

In another implementation, if the rule is breached, the current user input instructions may be immediately saved to memory, followed by returning each of the one or more areas of work machine functionality to the default state. Then an attempt may be made to reinitiate/reset/reboot the user interface. If the reboot is successful, then the user input instructions may be retrieved from memory and applied to the one or more functionality controllers. If the reboot is unsuccessful then the work machine functionality will remain in the default state.

The monitoring system may comprise a timer configured to count down from a starting value and to reset to the starting value every time the monitoring system receives one of the plurality of operation status indicators. In this arrangement, the plurality of operation status indicators is determined not to be received in accordance with the rule in circumstances where the timer counts down to zero.

The user interface may be configured to output the plurality of operation status indicators in accordance with a timetable only when the user interface is capable of receiving the user input instructions.

The one or more areas of work machine functionality may comprise any one or more of the following: headlights, work lights, cab lights, heating, ventilation, air-conditioning, entertainment, and satellite navigation. It may also include any other areas of work machine functionality as appropriate.

The monitoring system may comprise a monitoring processor, the user interface may comprise a user interface processor, and the functionality controller may comprise a functionality processor. The monitoring processor, the user interface processor and the functionality processor comprise independent hardware from each other.

The monitoring system may comprise a software watchdog system. The monitoring system may comprise a hardware watchdog system.

1. A work machine comprising:
one or more functionality controllers configured to control one or more areas of work machine functionality;
a user interface configured to:
(a) receive user input instructions in relation to the one or more areas of work machine functionality;
(b) send the user input instructions to the one or more functionality controllers; and
(c) output a plurality of operation status indicators in accordance with
a timetable; and
a monitoring system configured to receive the plurality of operation status indicators and to determine whether the plurality of operation status indicators is received in accordance with a rule;
wherein the monitoring system is configured such that, in an event that the plurality of operation status indicators is determined not to be received in accordance with the rule, the monitoring system provides an instruction to the one or more functionality controllers to return each of the one or more of areas of work machine functionality to a default state.

2. The work machine of claim 1 wherein the monitoring system is further configured such that:
in an event that the plurality of operation status indicators is determined not to be received in accordance with the rule, the monitoring system is configured to provide a command to the user interface to reinitiate the user interface; and
in an event that, following reinitiation of the user interface, the monitoring system continues to determine that the plurality of operation status indicators is not received in accordance with the rule, the monitoring system provides the instruction to the functionality controller to return each of the one or more areas of work machine functionality to the default state.

3. The work machine of claim 2 wherein the command to the user interface to reinitiate the user interface comprises a soft reset of the user interface.

4. The work machine of claim 2 wherein the command to the user interface to reinitiate the user interface comprises a hard reset of the user interface.

5. The work machine of claim 1 further comprising a communications network configured to transmit data, the communications network connecting the functionality controller, the user interface, and the monitoring system, wherein the data comprises user input instructions and the plurality of operation status indicators.

6. The work machine of claim 2 wherein the step of reinitiate of the user interface comprises first saving user input instructions to the one or more functionality controllers to memory prior to providing the command to the user interface to reinitiate the user interface and, once the user interface is reinitiated, retrieving the user input instructions from memory and sending the saved user input instructions to the one or more functionality controllers.

7. The work machine of claim 1 wherein the plurality of operation status indicators output in accordance with the timetable comprises a status ping output at a fixed frequency.

8. The work machine of claim 7 wherein the rule comprises determining whether a duration of time which is the same as or longer than a period equivalent to the frequency of the status ping has been exceeded since a most recently received status ping.

9. The work machine of claim 1 wherein the monitoring system comprises a timer configured to count down from a starting value, wherein the timer resets to the starting value every time the monitoring system receives one of the plurality of operation status indicators, and wherein the plurality of operation status indicators is determined not to be received in accordance with the rule in circumstances where the timer counts down to zero.

10. The work machine of claim 1 wherein the user interface is configured to output the plurality of operation status indicators in accordance with a timetable only when the user interface is capable of receiving the user input instructions.

11. The work machine of preceding claim 1 wherein the one or more areas of work machine functionality comprises one or more of:
headlights,
work lights,
heating,
ventilation,
air-conditioning,
entertainment, and
satellite navigation.

12. The work machine of claim 1 wherein the monitoring system comprises a monitoring processor; the user interface comprises a user interface processor, and the functionality controller comprises a functionality processor;
wherein the monitoring system, the user interface processor and the functionality processor comprise independent hardware from each other.

13. A method of operating a work machine, the work machine comprising:
one or more functionality controllers configured to control one or more areas of work machine functionality;
a user interface configured to:
(a) receive user input instructions in relation to the one or more areas of work machine functionality;
(b) send the user input instructions to the one or more functionality controllers; and
(c) output a plurality of operation status indicators in accordance with a timetable; and
a monitoring system configured to receive the plurality of operation status indicators and to determine whether the plurality of operation status indicators is received in accordance with a rule;
wherein the method comprises:
outputting, by the user interface, the plurality of operation status indicators in accordance with the timetable in circumstances where the user interface is capable of receiving the user input instructions;
receiving, by the monitoring system, the plurality of operation status indicators;
determining, by the monitoring system, whether the plurality of operation status indicators is received in accordance with the rule; and
in an event that the plurality of operation status indicators is determined not to be received in accordance with the rule: instructing the functionality controller to return each of the one or more areas of work machine functionality to a default state.

14. The method of claim 13 wherein:
in an event that the plurality of operation status indicators is determined not to be received in accordance with the rule, the method comprises first providing an instruction to the user interface to reinitiate the user interface; and
following reinitiation of the user interface, in an event that the plurality of operation status indicators continues to be determined not to be received in accordance with the rule, instructing the functionality controller to return each of the one or more areas of work machine functionality to a safe state.

15. The method of claim 13 wherein the plurality of operation status indicators output in accordance with the timetable comprises a status ping output at a fixed frequency and, optionally, wherein the rule comprises determining whether a duration of time which is the same as or longer than a period equivalent to the frequency of the status ping has been exceeded since a most recently received status ping.

16. The method of claim 13 wherein the monitoring system comprises a timer configured to count down from a starting value, wherein the timer resets to the starting value every time the monitoring system receives one of the plurality of operation status indicators, and wherein the plurality of operation status indicators is determined not to be received in accordance with the rule in circumstances where the timer counts down to zero.

17. The method of claim 13 wherein the user input instructions and the plurality of operation status indicators are transmitted over a communications network that connects the functionality controller, the user interface and the monitoring system.

18. The method of claim 13 wherein plurality of operation status indicators is output by the user interface in accordance with a timetable only when the user interface is capable of receiving the user input instructions.
